(19) United States
(12) Patent Application Publication
(10) Pub. No.: US 2025/0357757 A1
(43) Pub. Date: Nov. 20, 2025

(54) SYSTEM AND METHOD FOR RELIEVING A LOCAL POWER GRID AND A HIGHER-LEVEL POWER GRID

(71) Applicant: MUELLER SERVICE GMBH, Kempten Allgaeu (DE)

(72) Inventors: Maximilian Wegener, Kempten Allgaeu (DE); Moritz Wollbrink, Kempten Allgaeu (DE); Johannes Lichtenstern, Kempten Allgaeu (DE)

(21) Appl. No.: 19/129,267

(22) PCT Filed: Oct. 19, 2023
(86) PCT No.: PCT/DE2023/100782

§ 371 Date: May 12, 2025

(30) Foreign Application Priority Data
Nov. 10, 2022 (DE) 1020221297937

(51) Int. Cl. H02J 3/14; B60L 55/00; H02J 3/00

(52) U.S. Cl. CPC H02J 3/144; B60L 55/00; H02J 3/001; H02J 3/003; H02J 2203/10; H02J 2310/60

(57) ABSTRACT

The invention relates to a system (1) for relieving a local power grid (2) and a higher-level power grid (4) which are electrically coupled to each other at a grid feed-in point (6), comprising at least one charging unit (8) which can be electrically connected to the local power grid (2) for electrically charging an electrically operated vehicle (10, 14), wherein the charging unit (8) has a power storage device (18), a computing unit (20) coupled by signals to the at least one charging unit (8) and having a processor (22), a data memory (24) and a receiving unit (26) for receiving grid data, which represent at least one demand for electrical power from the local power grid (2) and a grid frequency of the higher-level power grid (4), wherein the computing unit (20) is adapted to determine, based on the grid data, an electrical power to be supplied to the higher-level power grid (4) and/or the local power grid (2), and wherein the computing unit (20) is adapted to control charging and/or discharging of the power storage device (18) in such a way that the determined electrical power is supplied to the higher-level power grid (4) and/or the local power grid (2).

The invention relates to a system and method for relieving a local power grid and a higher-level power grid, a computing unit, a local power grid, a data processing device, a computer program product, a computer-readable data carrier, and a data carrier signal.

Systems for relieving local power grids and higher-level power grids are generally known. A power grid is generally understood to be a grid for transmitting and distributing electrical energy, also referred to as an electricity grid. A power grid comprises electrical lines such as overhead lines and underground cables, as well as associated equipment such as switching stations and substations.

Power grids can be classified according to their voltage, for example, distinguishing between extra-high voltage, high voltage, medium voltage, and low voltage. Higher-level power grids are generally characterized by the fact that they distribute electricity. A local power grid usually supplies consumers such as private households, office buildings, and commercial units. In addition to the consumers mentioned above, local power grids may also include power generators, such as photovoltaic systems.

Due to the increased use of renewable energies, power production fluctuates more than was anticipated when existing power grids were built, making it more complex to maintain a predefined grid frequency. Furthermore, electricity demand in private households and commercial units is rising steadily as more and more electrically powered units are being used. This includes, among other things, the use of electrically powered vehicles for private and commercial purposes.

Electrically powered vehicles are usually charged using charging units. Charging units often have a maximum charging capacity of several hundred kilowatts. Local power grids are often not configured for such charging units. Charging units for charging electrically powered vehicles can therefore have power storage devices in order to provide high charging capacities for short periods of time. A short-term supply of charging power is usually sufficient, as the maximum possible charging power decreases as the charge level of an electric vehicle's battery increases. Therefore, the high-priced power storage devices of charging units are rarely in operation.

U.S. Pat. No. 11,007,891 B1 discloses a system for supplying fast charging power to electrically powered vehicles, whereby power can be supplied to a local power grid by means of local energy management. One disadvantage of this system is that it does not address the higher-level power grid and therefore does not address the challenges described above with regard to the higher-level power grid. DE 10 2016 008 666 A1, DE 10 2017 108 579 A1, US 2018/0358839 A1, and EP 3 442 823 B1 describe further approaches for supplying charging power to electrically powered vehicles.

It is an object of the invention to provide a system and method for relieving a local power grid and a higher-level power grid, a computing unit, a local power grid, a data processing device, a computer program product, a computer-readable data carrier, and a data carrier signal that reduce or eliminate one or more of the aforementioned disadvantages. In particular, it is an object of the invention to provide a solution that enables the load on a local power grid and a higher-level power grid to be reduced.

This problem is solved by a system, a computing unit, a computer-implemented method, a data processing device, a computer program product, a computer-readable data carrier and a data carrier signal according to the features of the independent patent claims. Further advantageous embodiments of these aspects are specified in the respective dependent patent claims. The features disclosed in the patent claims, the description, and the drawings are individual and can be combined with one another in any technologically meaningful way, thereby demonstrating further embodiments of the invention.

According to a first aspect, the problem is solved by a system for relieving a local power grid and a higher-level power grid, which are electrically coupled to each other at a grid feed-in point, comprising at least one charging unit electrically connectable to the local power grid for electrically charging an electrically operated vehicle, wherein the charging unit has a power storage device, a computing unit coupled by signals to the at least one charging unit and having a processor, a data memory and a receiving unit for receiving grid data representing at least a demand for electrical power from the local power grid and a grid frequency of the higher-level power grid, wherein the computing unit is adapted in order to determine, based on the grid data, an electrical power to be supplied to the higher-level power grid and/or the local power grid, and wherein the computing unit is adapted to control charging and/or discharging of the power storage device in such a way that the determined electrical power is supplied to the higher-level power grid and/or the local power grid.

The invention is based on the finding that a system for relieving a local power grid and a higher-level power grid must be designed in order to meet the diverse technical requirements placed on power grids. The invention was also based on the finding that the electrical power stored in charging units for electrically powered vehicles should ideally not be used statically for a single application, but should be supplied either to the local power grid or to the higher-level power grid depending on demand. Thus, depending on the urgency, the electricity can be supplied either to the local power grid, for example for peak load capping, or to the higher-level power grid, for example for frequency stabilization. It is obvious to those skilled in the art that a charging unit located in a local power grid always supplies electrical power directly to the local power grid and not directly to a higher-level power grid, even if the electrical power is to be supplied to the higher-level power grid.

The system is configured to relieve the local power grid and the higher-level power grid, whereby the local power grid and the higher-level power grid are not part of the system. In intended operation, the system is embedded in the local power grid and/or the higher-level power grid.

A local power grid is understood to mean, in particular, a power grid that supplies private and/or commercial consumers with electricity. The local power grid can be, for example, an area grid and/or a distribution grid. The local power grid can be configured as a medium-voltage or low-voltage grid. A higher-level power grid is understood to mean, in particular, a power grid that supplies local power grids with electricity. The higher-level power grid can be a transmission grid, for example. Large power generation systems, such as power plants or wind farms, are usually arranged in higher-level power grids. This does not, of course, exclude the possibility of power generation systems, such as photovoltaic systems, also being arranged in local power grids.

The system comprises at least one charging unit that can be electrically connected to the local power grid for the purpose of electrically charging an electrically powered vehicle, wherein the charging unit has a power storage device. Such a charging unit is also referred to as a charging point or charging station. Electrically powered vehicles can, for example, be electrically connected to the charging unit by means of a charging cable so that electrical power can be transferred from the charging unit to a battery of the electrically powered vehicle. The power storage device can in particular be a battery. In particular, the battery may have an already reduced state of life, for example because the battery was previously used in an electrically powered vehicle.

The system also comprises the computing unit coupled by signals to the at least one charging unit. The computing unit has the processor, the data memory and the receiving unit for receiving grid data. The processor, the data memory and/or the receiving unit may be arranged and/or configured separately and/or at different locations from one another. Individual components of the computing unit may be located in a cloud or mapped in a cloud or the cloud. Furthermore, these may be configured and/or arranged in combination. For this purpose, the computing unit or components of the computing unit may be coupled to the cloud by signals. The signal coupling may, for example, be wired or wireless, in particular by means of mobile communications. The computing unit may, for example, be a computer or comprise a computer. The computing unit may be arranged independently of the charging unit and/or the local power grid, whereby a signal coupling for data exchange is particularly necessary.

The grid data represent at least a demand for electrical power from the local power grid and a grid frequency of the higher-level power grid. The grid data can directly or indirectly represent the demand for electrical power from the local power grid and the grid frequency of the higher-level power grid.

The demand for electrical power from the local power grid can be a current demand or a forecast demand. The current demand and/or the forecast demand can, for example, be a sum of the demands of the consumers arranged in the local power grid. Furthermore, this can be represented in the form of a grid frequency, a voltage, an electricity price, and/or a current. In addition, the demand for electrical power may be based on raw material prices and/or weather conditions.

The grid frequency of the higher-level power grid can usually be recorded in real time and data representing the grid frequency can be supplied. The grid frequency drops when power consumption exceeds power generation. The grid frequency rises when power consumption is lower than power generation. Since the grid frequency must be kept essentially constant, frequency stabilization can be achieved by feeding electricity into or withdrawing electricity from the grid.

The computing unit is adapted to determine the electrical power to be supplied to the higher-level power grid and/or the local power grid based on the grid data. The determined electrical power can be determined, among other things, as a function of the available electrical power, a capacity, and/or an energy content of the power storage device. In practice, electrical power to be supplied to the higher-level power grid is usually marketed. For this purpose, an expected price is forecast in order to generate an economically optimized schedule for storage marketing on this basis and taking into account a load forecast.

The computing unit is further adapted to control charging and/or discharging of the power storage device in such a way that the determined electrical power is supplied to the higher-level power grid and/or the local power grid. In other words, the computing unit is adapted to determine an electrical power to be supplied, for example for peak load capping or for grid frequency stabilization, as will be explained in more detail below, and then to control the power storage device in such a way that this electrical power is supplied. The electrical power to be supplied is preferably determined by the computing unit based, among other things, on an available capacity, in particular that of the charging unit.

The charging unit within the local power grid thus serves a higher-level function, namely, in addition to supplying electrical power to the local power grid, it also acts on the higher-level power grid. The supply of electrical energy to the local power grid also indirectly influences the higher-level power grid, since, for example, the electrical power to be supplied to the local power grid can be reduced by the higher-level power grid. In addition to frequency stabilization and peak load capping, the system offers a temporal shift of local consumption and generation, enabling atypical grid usage. Furthermore, electrical power can be stored in the event of excess power production, for example when renewable energy sources generate high electrical power.

In a preferred embodiment of the system, the electrical power to be supplied to the higher-level power grid is a control power or comprises a control power in order to influence the grid frequency of the higher-level power grid. If the power generation is lower than the power demand, the grid frequency of a higher-level power grid is reduced. This effect is counteracted by feeding additional electrical power into the higher-level power grid. Such electrical power, referred to as control power, is supplied by the power storage device of the charging unit. This stabilizes the higher-level power grid and also provides economic advantages for the operator of the charging unit.

It is also preferable that the electrical power to be supplied to the local power grid is peak load power or comprises peak load power in order to reduce the electrical power to be supplied to the local power grid from the higher-level power grid. Peak load power is applied for peak load capping. Particularly during periods of high energy consumption within the local power grid, the supply of peak load power can be advantageous in order to relieve the higher-level power grid on the one hand and to take advantage of the high electricity prices typical during this time for the operator of the charging unit on the other hand.

In a further preferred embodiment of the system, the system comprises two or more charging units with power storage devices, and the computing unit is adapted to map the two or more power storage devices in a data model as a virtual power plant and to determine excess power of the power storage devices and to control the discharging of the power storage devices in such a way that the excess power of the power storage devices is supplied to the higher-level power grid. The computing unit or components of the computing unit are preferably mapped in a cloud.

The excess power of the two or more power storage devices is, in particular, available electrical power minus reserve power. Such reserve power is usually provided to cover existing supply obligations.

A further preferred development of the system is characterized in that the computing unit is adapted to predict the power demand of the local power grid and/or the higher-level power grid based on the grid data and to determine, depending on this power demand, whether the peak load power or the control power is supplied.

The power demand of the local power grid and/or the higher-level power grid can be predicted directly or indirectly. The power demand can also be determined abstractly. For example, depending on whether the power demand of the local power grid or the higher-level power grid is higher, the higher power demand can be served. A higher power demand can be determined, for example, by means of a power price.

In a further preferred embodiment, the computing unit is adapted to generate, based on the grid data, a time-dependent first forecast demand for the control power and a time-dependent second forecast demand for the peak load power for a predetermined period of time, and the computing unit is further adapted to to determine, depending on the first forecast value and the second forecast value, whether the peak load power or the control power is supplied. With a computing unit adapted in such a way, a plan for coordinating the different power requirements and/or for supplying the different functions, also referred to as a power schedule, can be generated, which can be operated by means of the charging unit and the power storage device, among other things.

In a further preferred embodiment of the system, the charging unit is arranged and configured to supply charging power to an electrically powered vehicle in such a way that the peak load power or the control power can be supplied, in particular without restriction. For example, the charging power can be reduced in order to supply the peak load power or the control power.

It is also preferred that the charging unit is arranged and configured to provide negative charging power in order to ensure the supply of peak load power or control power. For example, the electrical power stored in a battery of an electrically powered vehicle can thus be used to provide the peak load power and/or the control power.

In a further preferred embodiment of the system, the grid data represent a power demand or a forecast value of the power demand of power consumers arranged in the local power grid and/or a forecast power consumption in the higher-level power grid. The power demand, the forecast value of the power demand or the forecast power consumption can be represented directly or indirectly.

A preferred further development of the system is characterized in that the charging unit is arranged and configured to supply emergency electrical power to a sub grid of the local power grid or to the local power grid, and the computing unit is adapted to detect a failure of the higher-level power grid and to control the charging unit in such a way that the emergency power is supplied to the sub grid and/or the local power grid when the failure is detected. With a charging unit configured in such a way, emergency power can be advantageously provided to a consumer when a normal power supply is not available.

Furthermore, it may be preferable that the emergency power is used for black start in order to restart the local power grid after a failure of the higher-level power grid, whereby a grid frequency is maintained.

According to a further aspect, the problem mentioned at the beginning is solved by a computing unit with a processor, a data memory and a receiving unit for receiving grid data, which represent at least a demand for electrical power from a local power grid and a grid frequency of a higher-level power grid, wherein the computing unit can be signal-technically coupled to a charging unit comprising a power storage device for electrically charging an electrically operated vehicle, wherein the computing unit is adapted in order to determine, based on the grid data, an electrical power to be supplied to the higher-level power grid and/or the local power grid, and wherein the computing unit is adapted to control charging and discharging of the power storage device in such a way that the determined electrical power is supplied to the higher-level power grid and/or the local power grid.

According to a further aspect, the problem mentioned at the beginning is solved by a local power grid which, in normal operation, can be electrically coupled to a grid feed-in point with a higher-level power grid, comprising a system or a computing unit according to one of the embodiments described above.

According to a further aspect, the problem mentioned at the beginning is solved by a computer-implemented method for relieving a local power grid and a higher-level power grid, which are electrically coupled to each other at a grid feed-in point, comprising the steps: receiving grid data representing at least a demand for electrical power from the local power grid and a grid frequency of the higher-level power grid, determining electrical power to be supplied to the higher-level power grid and/or the local power grid based on the grid data, and controlling a charging unit with a power storage device for electrically charging an electrically operated vehicle in such a way that, based on the determined electrical power, the power storage device is charged and/or discharged so that the determined electrical power is supplied to the higher-level power grid and/or the local power grid.

In a preferred further development of the computer-implemented method, it is provided that the electrical power supplied to the higher-level power grid is or comprises control power in order to influence the grid frequency of the higher-level power grid. Furthermore, it is preferred that the electrical power supplied to the local power grid is or comprises peak load power in order to reduce electrical power to be supplied to the local power grid from the higher-level power grid.

In a further preferred embodiment of the computer-implemented method, it is provided that this comprises the step of: predicting an electricity demand of the local power grid and/or the higher-level power grid based on the grid data, and supplying the peak load power or the control power depending on the predicted electricity demand so that the higher electricity demand is met. This embodiment provides that the power demand of the local power grid and the higher-level power grid is first predicted and, based on this, a decision is made as to whether the peak load power or the control power is supplied. This decision is based on the finding as to whether the power demand of the local power grid or the higher-level power grid is higher. In particular, the power demand of the higher-level power grid is, of course, the power that can be supplied by the power storage device. Furthermore, it is preferred that the decision as to whether the peak load power or the control power is supplied is made depending on the power demand.

In a further preferred embodiment of the computer-implemented method, it is provided that this comprises the steps of: detecting a failure of the higher-level power grid, and supplying emergency power to a sub grid of the local power grid or to the local power grid when the failure is detected.

According to a further aspect, the problem mentioned at the beginning is solved by a data processing device, in particular a computing unit according to the embodiment described above, comprising means for performing the steps of the method in one of the embodiments described above.

According to a further aspect, the problem mentioned at the beginning is solved by a computer program product comprising instructions which, when the program is executed by a processor, cause the processor to perform the steps of the method according to one of the embodiments described above.

According to a further aspect, the task mentioned at the beginning is solved by a computer-readable data carrier on which the computer program product is stored according to the aspect described above.

According to a further aspect, the task mentioned at the beginning is solved by a data carrier signal that transmits the computer program product according to the aspect described above.

For further advantages, embodiments, and implementation details of the individual aspects and their possible further developments, reference is also made to the description of the further aspects, the corresponding features, and further developments.

Preferred embodiments are explained by way of example with reference to the accompanying figures. These show:

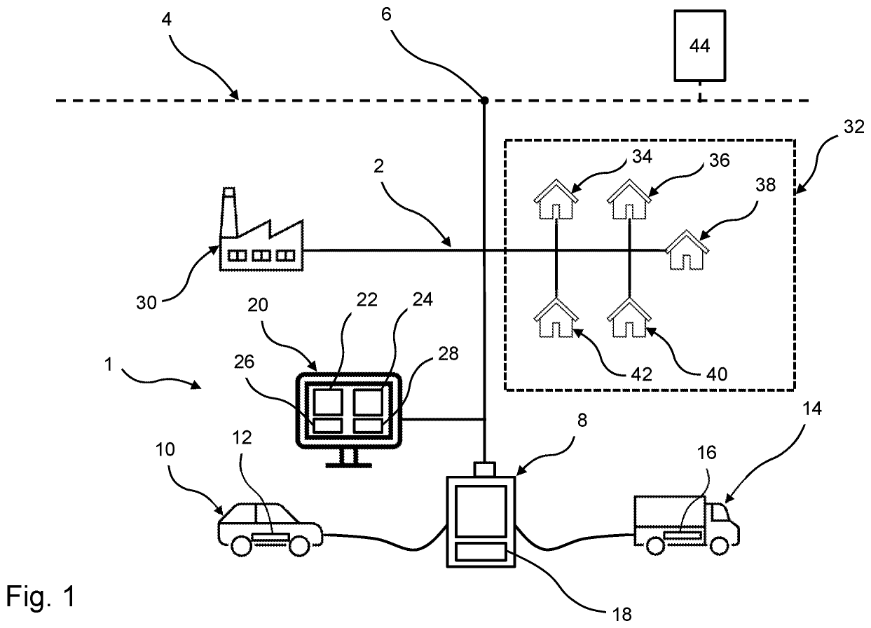

FIG. 1: a schematic view of an exemplary embodiment of a system for relieving a local power grid and a higher-level power grid;

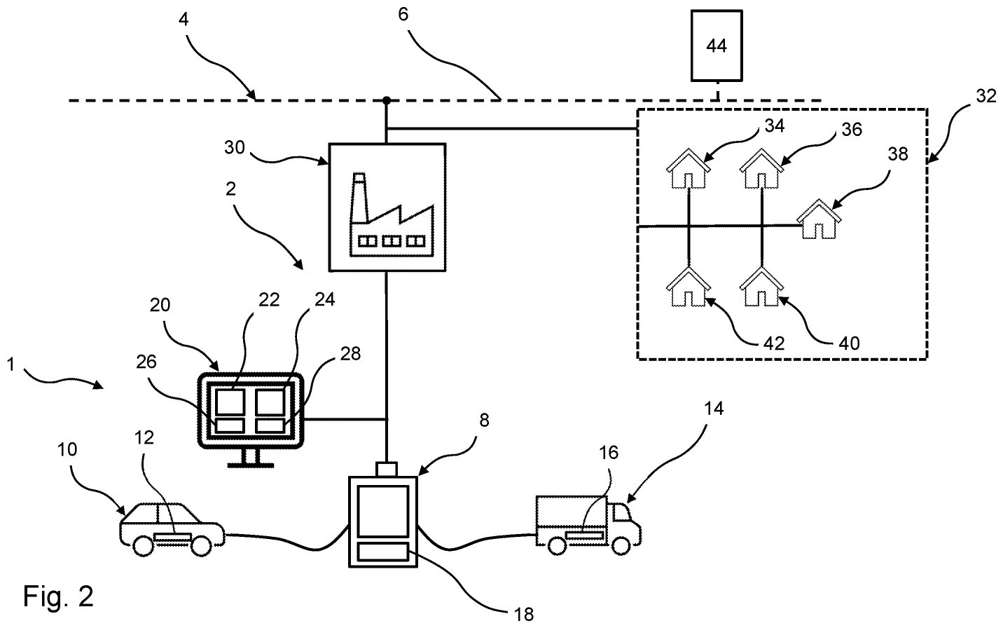

FIG. 2: a schematic view of an exemplary embodiment of a system for relieving a local power grid and a higher-level power grid;

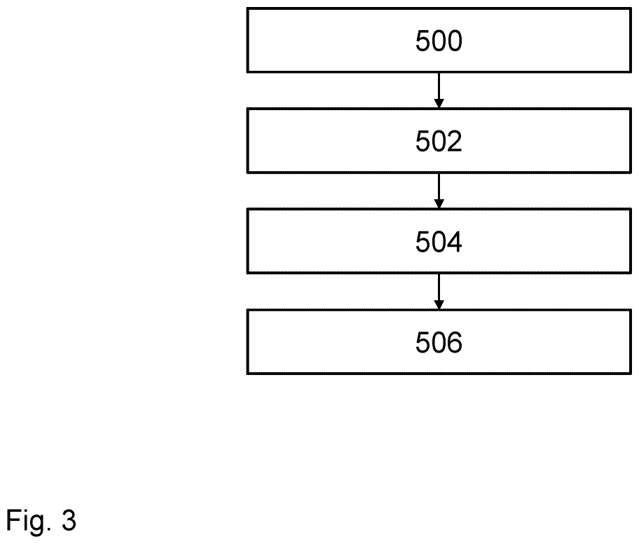

FIG. 3: a schematic view of an exemplary method for relieving a local power grid and a higher-level power grid.

In the figures, identical or essentially functionally identical or similar elements are designated with the same reference signs.

FIGS. 1 and 2 show a system 1 for relieving a local power grid 2 and a higher-level power grid 4, which are electrically coupled to each other at a grid feed-in point 6. A substation can operate at the grid feed-in point 6, for example, in order to reduce the voltage of the higher-level power grid 4 for the local power grid 2. A power plant 44 is coupled to the higher-level power grid 4, which supplies electrical energy.

Various consumers are arranged in the local power grid 2, including a commercial unit 30 and private consumers 34-42, which are arranged within a subgrid 32. The commercial unit 30 and/or the private consumers 34-42 can also act as power generators temporarily or permanently. A charging unit 8 for electrically charging electrically powered vehicles 10, 12 is provided with the local power grid 2. The charging unit 8 comprises a power storage device 18, which can be configured as a battery, for example. The charging unit 8 can be used to charge batteries 12, 16 of the vehicles 10, 14.

A computing unit 20 is also coupled by signals to the charging unit 8. The computing unit 20 comprises a processor 22, a data memory 24, a receiving unit 26, and a transmitting unit 28. The receiving unit 26 is configured to receive grid data. The grid data represents at least a demand for electrical power from the local power grid 2 and a grid frequency of the higher-level power grid 4.

The computing unit 20 is adapted to determine, based on this grid data, an electrical power to be supplied to the higher-level power grid 4 and/or the local power grid 2. The electrical power to be supplied to the higher-level power grid 4 can, for example, be a control power in order to influence the grid frequency of the higher-level power grid 4. This can be used in particular for frequency stabilization.

In addition, the electrical power can be a peak load power for the local power grid 2 in order to reduce an electrical power to be supplied to the local power grid 2 from the higher-level power grid 4. Particularly at times of high demand for electrical power within the local power grid 2, such a peak load power may be desirable for peak load capping in order to reduce the costs for the electricity to be provided.

The computing unit 20 is also adapted to map a plurality of power storage devices from a plurality of charging units not shown here in a data model as a virtual power plant. By means of the virtual power plant, the computing unit 20 can determine excess power of the power storage devices. In addition, the computing unit 20 can control the discharging of the power storage devices or of part of the power storage device or of the power storage devices in such a way that the excess power of the power storage devices is supplied to the higher-level power grid 4. Such a supply of excess power may be desirable, in particular at times when frequency stabilization is required in the higher-level power grid 4.

The charging unit 8 is further arranged and configured to supply emergency electrical power to the sub grid 32. For this purpose, the computing unit 20 is adapted to detect a failure of the higher-level power grid 4 and to control the charging unit 8 in such a way that the emergency power is supplied when the failure is detected.

FIG. 3 shows a schematic view of an exemplary computer-implemented method for relieving a local power grid 2 and a higher-level power grid 4. In step 500, grid data is received which at least represents the demand for electrical power of the local power grid 2 and the grid frequency of the higher-level power grid 4. In step 502, the power demand of the local power grid 2 and the higher-level power grid 4 is predicted based on the grid data. This prediction can be made on the basis of different grid data, which is possible on the one hand technically and on the other hand indirectly by means of economic data.

In step 504, an electrical power to be supplied to the higher-level power grid 4 and/or the local power grid 2 is determined based on the grid data and/or based on the predicted power demand.

In step 506, the charging unit 8 is controlled so that, based on the determined electrical power, the power storage device 18 of the charging unit 8 is charged or discharged so that the determined electrical power is supplied to the higher-level power grid 4 and/or the local power grid 2.

The system described above and the corresponding computer-implemented method have the advantage that, by means of the charging unit and, in particular, a plurality of charging units, it is possible to exert a significant influence on a local power grid and, at the same time, on a higher-level power grid, for example a supply grid. This multiple function is necessary in order to address the different demands in the local power grid and in the higher-level power grid and, in particular, to utilize the power storage device of the charging unit 8 as permanently as possible. Due to the high cost of a power storage device 18, it can be used particularly economically if it can be used for other applications outside of the actual charging and the local power grid 2. Thus, the system 1 contributes to the technical improvement of the applied power grids 2, 4 and also leads to an economical use of charging units 8 with power storage devices 18.

### REFERENCE SIGNS

1 System
2 Local power grid
4 Higher-level power grid
6 Grid feed-in point
8 Charging unit
10 Vehicle
12 Battery
14 Vehicle
10 16 Battery
18 Power storage device
20 Computing unit
22 Processor
24 Data storage
26 Receiving unit
28 Transmitting unit
30 Commercial unit
32 Subgrid
34 Consumer
36 Consumer
38 Consumer
40 Consumer
42 Consumer
44 Power plant

1. A system for relieving a local power grid and a higher-level power grid which are electrically coupled to each other at a grid feed point, comprising
at least one charging unit electrically connectable to the local power grid for electrically charging an electrically operated vehicle, wherein the charging unit has a power storage device,
a computing unit coupled by signals to the at least one charging unit and having a processor, a data memory and a receiving unit for receiving grid data, representing at least a demand for electrical power from the local power grid and a grid frequency of the higher-level power grid
wherein the computing unit is adapted to determine, based on the grid data, an electrical power to be supplied to the higher-level power grid and/or the local power grid, and
wherein the computing unit is adapted to control charging and/or discharging of the power storage device in such a way that the determined electrical power is supplied to the higher-level power grid and/or the local power grid.

2. The system according to claim 1, wherein
the electrical power to be supplied to the higher-level power grid is a control power or comprises a control power in order to influence the grid frequency of the higher-level power grid, and/or
the electrical power to be supplied to the local power grid is a peak load power or comprises a peak load power in order to reduce an electrical power to be supplied to the local power grid from the higher-level power grid.

3. The system according to claim 1, wherein
the system comprises two or more charging units with power storage devices, and
the computing unit is adapted to map the two or more electricity storage devices in a data model as a virtual power plant and to determine excess power of the power storage devices and to control discharging of the power storage devices in such a way that the excess power of the power storage devices is supplied to the higher-level power grid.

4. The system according to claim 1, wherein
the computing unit is adapted to predict an electricity demand of the local power grid and/or the higher-level power grid based on the grid data and to determine, depending on this electricity demand, whether the peak load power or the control power is supplied.

5. The system according to claim 1, wherein
the computing unit is adapted to generate, based on the grid data, a time-dependent first forecast demand for the control power and a time-dependent second forecast demand for the peak load power for a predetermined period of time, and
the computing unit is adapted to determine, depending on the first forecast value and the second forecast value, whether the peak load power or the control power is supplied.

6. The system according to claim 1, wherein
the charging unit is arranged and configured to supply charging power to an electrically powered vehicle in such a way that the peak load power or the control power can be supplied, in particular without restriction.

7. The system according to claim 1, wherein
the charging unit is arranged and configured to provide a negative charging power in order to ensure the supply of the peak load power or the control power.

8. The system according to claim 1, wherein
the grid data represent a current demand or a forecast value of the current demand of current consumers arranged in the local power grid and/or a forecast current consumption in the higher-level power grid.

9. The system according to claim 1, wherein
the charging unit is arranged and configured to supply emergency electrical power to a sub grid of the local power grid or to the local power grid, and
the computing unit is adapted to detect a failure of the higher-level power grid and to control the charging unit in such a way that the emergency power is supplied to the sub grid and/or the local power grid when the failure is detected.

10. A computing unit with a processor, a data memory and a receiving unit for receiving grid data representing at least a demand for electrical power from a local power grid and a grid frequency of a higher-level power grid,
wherein the computing unit can be coupled in a signal-technically appropriate manner to a charging unit comprising a power storage device for electrically charging an electrically operated vehicle,
wherein the computing unit is adapted to determine, based on the grid data, an electrical power to be supplied to the higher-level power grid and/or the local power grid, and
wherein the computing unit is adapted to control charging and discharging of the power storage device in such a way that the determined electrical power is supplied to the higher-level power grid and/or the local power grid.

11. A local power grid configured to be electrically coupled to a higher-level power grid at a grid feed-in point, comprising the system according to claim 1 or the computing unit according to claim 10.

12. A computer-implemented method for relieving a local power grid and a higher-level power grid which are electrically coupled to each other at a grid feed-in point, comprising the steps:
receiving grid data representing at least a demand for electrical power from the local power grid and a grid frequency of the higher-level power grid,
determining an electrical power to be supplied to the higher-level power grid and/or the local power grid based on the grid data, and
controlling a charging unit with a power storage device for electrically charging an electrically operated vehicle in such a way that, based on the determined electrical power, the power storage device is charged and/or discharged so that the determined electrical power is supplied to the higher-level power grid and/or local power grid.

13. The computer-implemented method according to claim 12, wherein
the electrical power supplied to the higher-level power grid is or comprises control power in order to influence the grid frequency of the higher-level power grid, and/or
the electrical power supplied to the local power grid is or comprises peak load power in order to reduce electrical power to be supplied to the local power grid from the higher-level power grid.

14. The computer-implemented method according to claim 12, comprising the step of:
predicting a power demand of the local power grid and/or the higher-level power grid based on the grid data, and
supplying the peak load power or the control power depending on the predicted power demand so that the higher power demand is met.

15. The computer-implemented method according to claim 12, comprising the steps of:
detecting a failure of the higher-level power grid, and
supplying emergency power to a sub grid of the local power grid or to the local power grid when the failure is detected.

16-19. (canceled)
